(19) United States
(12) Patent Application Publication
(10) Pub. No.: US 2009/0066114 A1
(43) Pub. Date: Mar. 12, 2009

(54) STOWABLE WAGON

(76) Inventor: Jeffrey A. Molton, Miamisburg, OH (US)

Correspondence Address: A PATENT LAWYER CORP, PLC;R WILLIAM GRAHAM, 22 S ST CLAIR ST, DAYTON, OH, 45402, US

(21) Appl. No.: 11/851,423

(22) Filed: Sep. 7, 2007

(51) Int. Cl. B60P 3/42

(52) U.S. Cl. 296/180; 296/187.01

(57) ABSTRACT

A stowable wagon includes a collapsible frame having a plurality of wheels operably connected to the frame, a handle operably connected to the frame, a case operably connected to the frame such that the frame and wheels in a first mode of operation support the case in a manner to permit articles to be carried within the case and a second mode of operation wherein the frame and wheels are contained within the case for storage thereof.

### BACKGROUND OF THE INVENTION

1. Field of the Invention

This invention relates to wagons. More particularly, the invention relates to a wagon small enough to be pulled by hand, strong enough to carry a significant load, and collapsible into units which can be easily stowed in a case that can be hand-carried and, when opened, serves as the body of the wagon.

2. Prior Art

There are many occasions when it is desirable to have a small, easily steerable, load-carrying wagon available for transporting small but heavy loads over terrain that may be far from smooth. There are numerous hand operated load-carrying devices equipped with wheels and capable of moving relatively small loads. Some devices can be broken down into separate components parts, but are not easily carried or storable in a user friendly manner.

The present invention over comes the deficiencies of the art by providing a wagon small enough to be easily packed into a container that can be hand-carried. Additionally the present invention overcomes the problem of stowing the wagon in a collapsible manner which can easily be stowed in a space saving manner.

### SUMMARY OF THE INVENTION

It is a primary object to improve wagons.

It is another object to provide a wagon that can be hand carried.

It is still another object to provide a wagon small enough to be towed by hand.

A further object is to provide a durable wagon which can be readily separated into sections small enough to be stowed in a hand held container.

It is another object to provide a collapsible wagon which breaks down into multiple components such that some components of the wagon serve a dual purpose of a container for other components in a storage mode and as the body for the wagon when the components are reassembled into a wagon.

It is another object to provide a wagon with a telescoping tow rod comprising of a universal swivel mount at the front frame, and a hinged handle that, when the wagon frame is stowed in its case, also serves as a handle for the case.

Persons skilled in the technology with which this invention is concerned may find that, after they have reviewed the following description, together with the drawings, still further objects will become apparent.

### BRIEF DESCRIPTION OF THE DRAWINGS

FIG. 1 is an orthographic view of the framework and wheels of a stowable wagon according to this invention.

FIG. 2 is a bottom view of the structure in FIG. 1.

FIG. 3 is a top view of the structure in FIG. 1 with its front and rear frame assemblies separated from each other.

FIG. 4 is a bottom view of the front left frame assembly showing some of the structure for controlling the position of the front wheel between its operating position and its stowed position.

FIG. 5 is an exploded view of the structure shown in FIG. 4.

FIG. 6 is a orthographic view of one embodiment of a wagon body for mounting on the structure in FIG. 1 with side rails in the extended and locked position.

FIG. 7 is an exploded view of the wagon body shown in FIG. 6

FIG. 8 is a side view of one embodiment of a wagon body mounted on the structure in FIG. 1.

FIG. 9 is a front view of the wagon body as shown in FIG. 6 body mounted on the structure in FIG. 1 and one front wheel is turned 90 degrees.

FIG. 10 is a rear view of the wagon body as shown in FIG. 6 body mounted on the structure in FIG. 1.

FIG. 11 is a front view of the frame and wheels as shown in FIG. 1 with the wheels pivoted inwardly to allow the frame assembly to be placed into a front section of the wagon body for storage.

FIG. 12 is a rear view of the frame and wheels as shown in FIG. 1 with the wheels pivoted inwardly to allow the rear frame assembly to be placed into a rear section of the wagon body for storage.

FIG. 13 is a top view of the wagon body forming a storage case with the other components of the structure separated and stowed therein.

FIG. 14 is an orthographic view of the wagon body in a storage case mode.

### DETAILED DESCRIPTION OF THE INVENTION

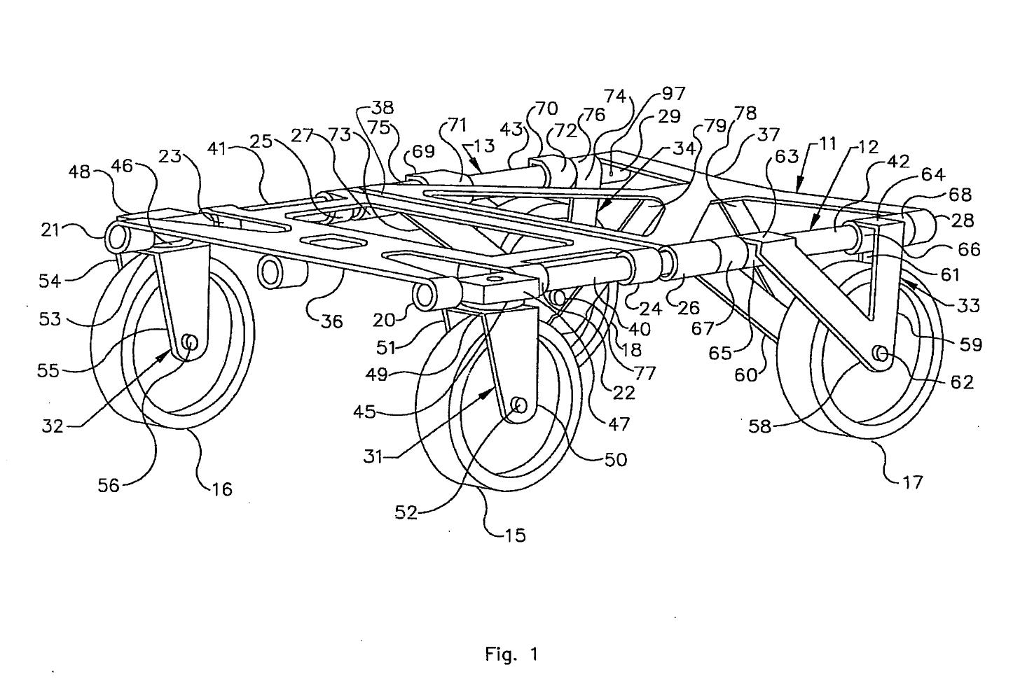

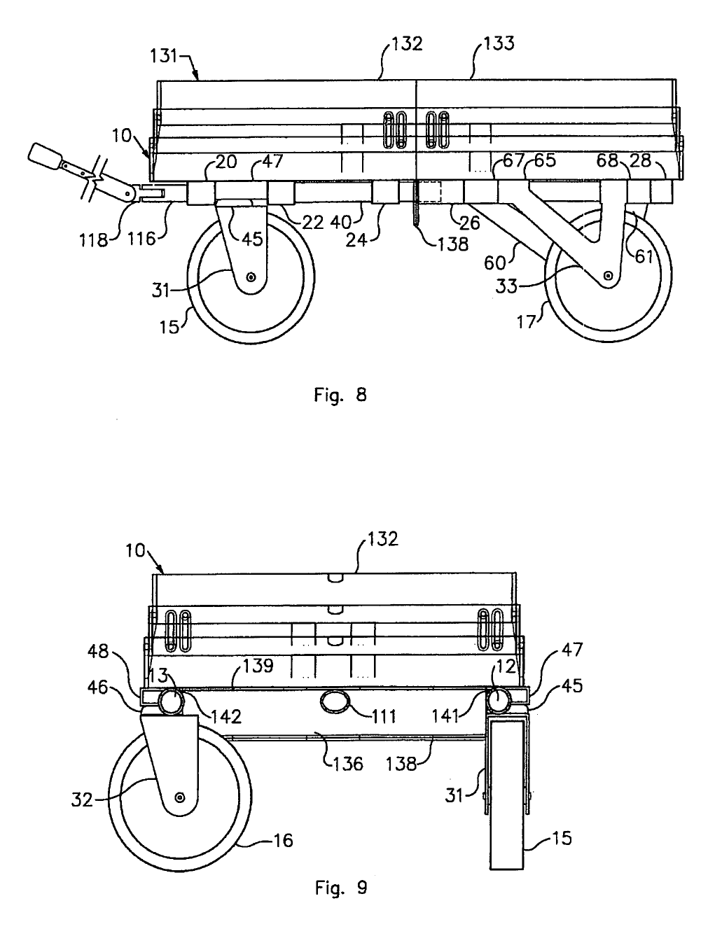

FIG. 8 generally depicts a stowable wagon according to the invention which is generally designated by the numeral 10. FIG. 1 shows frame 11 of wagon 10 constructed according to this invention. The frame 11 has longitudinal strengthening means in the form of cylindrical side members 12 and 13 which are joined to its left and right sides. Wheels 15, 16, 17 and 18 are operably connected to the members 12 and 13 and shown in their operating positions in which they provide rolling support for the frame 11.

Portions of the side edges of the frame 11 are formed with, or are rigidly joined to, tubes 20, 21, 22, 23, 24, 25, 26, 27, 28 and 29 that receive the cylindrical side members 12 and 13 and impart great strength to the frame 11. The wheels 15-18 are hingedly connected to pivoted about the axis to the members 12 and 13 from there operating positions to storage positions on the underside of the frame 11.

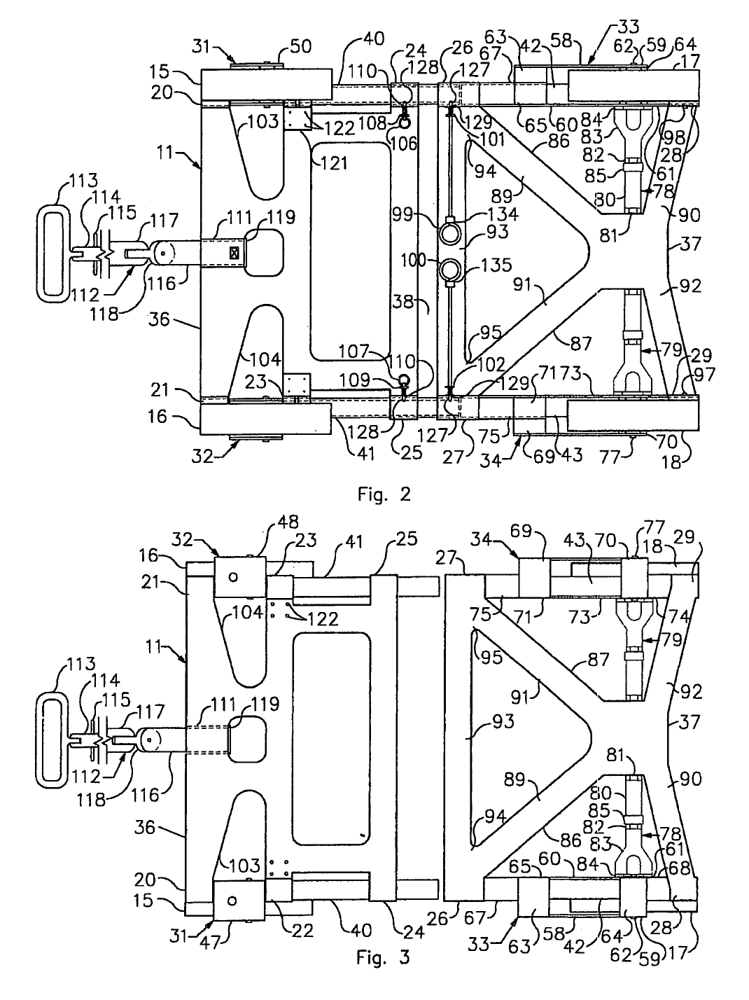

In order to facilitate stowing the wagon 10 away or transporting it as luggage from one place to another, the frame 11 is arranged to be separated into front and rear assemblies (parts) 36 and 37 which, when joined together as shown in FIG. 2, have a small gap 38 between them. Separation of the frame 11 is accomplished by the cylindrical side members 12 and 13 also being separated into left and right front cylindrical parts 40 and 41 and left and right rear cylindrical parts 42 and 43. This allows the wagon 10 to be transformed into a carrying case as seen in FIG. 14.

Two front wheel brackets 31 and 32 are operably connected to the front cylindrical side parts 40 and 41 via bearing 45 and 46 which connect to plates 47 and 48 which rigidly attach to the front cylindrical parts 40 and 41, respectively. When the wheels 15 and 16 are in their operating positions, as shown in FIG. 1, the bearings 45 and 46 allow the brackets 31 and 32 to be pivoted, or swiveled, left and right to facilitate guiding the wagon 10 as it is being pulled along.

It will be noted that the front wheel brackets 31 and 32 are generally U-shaped, in that the bracket 31 comprises an outer panel 50 extending down alongside the outwardly facing side of the wheel 15 and joined by flat side 49 which joins to an inner panel 51 that extends down alongside the inwardly facing side of that wheel 15. These panels 50 and 51 provide stable supports for an axle 52 of the wheel 15. The front wheel bracket 32 for the other front wheel 16 is a mirror image of the front wheel bracket 31 and includes a flat side 53 joining outer and inner panels 54 and 55 together to support axle 56. The axles 52 and 56 for the front wheels 15 and 16, respectively, can be preferably offset from being directly under the centers of the bearings 45 and 46 so that the front wheels 15 and 16 can caster, allowing the wagon to be easily pulled around a left or right curve as straight ahead.

The rear wheels 17 and 18 need not be configured to caster. The bracket 33 includes an outer set of struts 58 and 59 integrally joined together and an inner set of struts 60 and 61, which are also integrally joined together, both of which being arranged in a V configuration to hold the axle 62 for the wheel 17 and spaced wide enough to accommodate the width of the wheel 17. The outer struts 58 and 59 are shown as being bent 90 degrees at their top ends to form horizontal top plates 63 and 64, which is wider than the diameter of the cylindrical side member 12. The top plate 63 and 64 include a terminal connecting tube 65 and 66, respectively, that are rigidly spaced apart and have the same axial length along the rear cylindrical parts 42 as the plates 63 and 64. Similarly, the upper ends of the inner struts 60 and 61 include terminal connecting tubes 67 and 68, respectively, that are also rigidly spaced apart. The tubes 65, 66, 67, and 68 form parts of the bracket 33 and are operably connected on the rear cylindrical part 42 yet loose enough to allow bracket 33 to be pivoted from the operating position in which it is shown to a folded position under the rear part 37 of the frame 11 as seen in FIG. 12.

The rear wheel bracket 34 is a mirror image of the rear wheel bracket 33 and comprises similar V-shaped pairs of outer and inner sets of struts. However, very little of the outer set is visible in this drawing except for the horizontal top plates 69 and 70 that have tubes 71 and 72, respectfully, encircling the rear cylindrical part 43. The inner struts 73 and 74 of the rear wheel bracket 34 have tubes 75 and 76 at their upper ends. The tubes 71, 72, 75, and 76 are operably connected sufficiently loosely on the rear cylindrical part 43 to permit the rear wheel bracket 34 to pivot. It will be shown on later figures that each of the sets of struts in the rear wheel bracket 34 is arranged in a V configuration to hold the axle 77 for the wheel 18. In order to hold the rear wheels 17 and 18 in their side operating positions, the rear wheel brackets 33 and 34 are provided with folding diagonal braces 78 and 79, respectively.

FIG. 2 shows an underside of the frame 11 depicted in FIG. 1, and FIG. 3 shows the top of the frame 11 save for the front and rear parts 36 and 37 separated from each other and with the wheels 15-18 in their operating positions. The folding diagonal brace 78 comprises a straight, flat inner member 80 connected by a first hinge 81 to the rear part 37 of the frame 11 and by a second hinge 82 to a straight, flat outer member 83. The outer end of member 83 is connected by a third hinge 84 to the inner struts 60 and 61. An inner end of the outer member 83 is not visible in the drawing and overlaps part of the inner member 80 adjacent the second hinge 82, and a sleeve 85 is provided to slide over these overlapping parts to hold the inner and outer members 80 and 83 in alignment so as to keep the wheel 17 in its operating position.

When the wheel 17 is to be folded against the under surface of the rear part 37 on the frame 11, the sleeve 85 can be slid along the inner member 80 toward the hinge so that the outer member 83 can fold towards the inner member 80. The rear part 37 has two generally trapezoidal cutouts 86 and 87, each of a size and shape to accommodate the inner struts 60 and 61 of the bracket 33 and the inner struts 73 and 74 of the rear wheel bracket 34 to allow these brackets to fold flatter under the rear part 37. The folding diagonal brace 79 is similarly constructed to the folding diagonal brace 78 and, therefore need not be described in detail.

The rear part 37 of the frame 11 has a large open areas formed by relatively narrow slats. Slats 89 and 90 define part of the trapezoidal cutout 86, and slats 91 and 92 define part of the trapezoidal cutout 87. A slat 93 extends across a front edge of the rear part 37 and joins ends of the slats 89 and 91 at junction areas 94 and 95. The junction area 94 includes a joined tube 26, and the junction area 95 includes a joined to tube 27.

The rear part 37 of the frame 11 is lock to the rear cylindrical parts 42 and 43 of the cylindrical side member 12 and 13 by machine screws 97 and 98 that pass through the tubes 28 and 29 and are threaded into the rear cylindrical parts 42 and 43. This prevents any longitudinal or rotational movement of the tubes and, indeed, of the entire rear part 37, including the fronts tubes 26 and 27 with respect to the rear cylindrical parts.

The tubes 26 and 27 when operably disposed on rear cylindrical parts 42 and 43 are long enough to enclose and extend beyond the forward ends of the rear cylindrical parts 42 and 43, leaving space into which rear ends of the front cylindrical parts 40 and 41 can telescope and be received therein. When the front part 36 of the frame 11 is to be rigidly secured to the rear part 37 as in FIGS. 1 and 2, the rear ends of the front cylindrical parts 40 and 41 are inserted into the front ends of the tubes 26 and 27 and are then secured by spring biased locking pins 99 and 100 that extend through holes 129 in the tubes 26 and 27 and holes 127 aligned therewith in the front cylindrical parts 40 and 41. The locking pins 99 and 100 are mounted in tabs 101 and 102 rigidly attached to the junction areas 94 and 95, and substantial tabs 134 and 135 rigidly attach to proximate a mid point of slat 93 and are provided with rings to pull out both pins 99 and 100 at the same time, at least far enough to be disengaged from both sets of cylindrical parts.

The plates 47 and 48 and the front cylindrical parts 40 and 41 to which they can be rigidly attached to pivot as a unit about the axes of these cylindrical parts to change the positions of the front wheels 15 and 16 to their storage positions from the upright, or operating, positions in which they have thus far been shown. The front part 36 of the frame 11 has two cutouts 103 and 104 shaped to receive the inner panels 51 and 55 of the front wheel brackets 31 and 32 when the wheels 15 and 16 are in their storage positions. Two spring-biased locking pins 106 and 107 mounted in tabs 108 and 109, respectively, which are rigidly attached on the front part 36 adjacent the rear tubes 24 and 25 in positions to extend through holes 110 in tubes 24 and 25 and into holes 128 in the front cylindrical parts 40 to hold the wheels 15 and 16 in their operating positions. To allow the front cylindrical parts 40 and 41 and the wheels 15 and 16 to pivot to their storage positions, locking pins 106 and 107 are pulled back far enough to disengage from the front cylindrical parts 40 and 41.

At the center of the leading edge of the front part 36 of the frame 11 is a tube 111 that holds a collapsible handle 112 by which the wagon 10 may be pulled. The handle 112 comprises several telescoping sections of graduated sizes with latching means on each section to hold the section extended relative to each other. A handgrip 113 is pivotally attached to a forwardmost section 114 and a cross member 115 at a predetermined distance behind the handle 112. A section 116 at the other end of the handle 112 is attached to the preceding section 117 by a universal joint 118 to permit the handle 112 to be pivoted in any direction as the wagon 10 is being pulled along. The section 116 has a flange 119 at its rear end to prevent the handle 112 from being pulled free of tube 111.

The fact that the tubes 28 and 29 are held fixed on the rear cylindrical parts 42 and 43 provide that the tube 26 and 27 are also rigidly fixed on the rear cylindrical parts. The struts 58-61 that hold the axle 62 of the wheel 17 are held between the tubes 26 and 28, and the corresponding arrangement is also true for the wheel 18. As may be seen, the axial length of the tube 67 is such to permit it to fit on the rear cylindrical part 42 in the space between tube 26 and the tube 65 at inboard end of the plate 63. The tube 66 at inboard end of the plate 64 on the end of the strut 59 is part of the one-piece V-shaped strut structure comprising the struts 58 and 59 and is therefore spaced from the tubes 65 and 66 by a fixed distance. The tube 68 at the end of the inner strut 61 fits between the tubes 28 and 66 that hold the tube 68 in a fixed position against the tube 28. In addition, the tubes 67 and 68 are also parts of the one-piece V-shaped strut structure comprising the struts 60 and 61, which further prevents their moving longitudinally along the rear cylindrical part 42. Thus, the axles 62 and 77 of the wheels 17 and 18, respectively, are held in fixed longitudinal positions relative to the rear part 37.

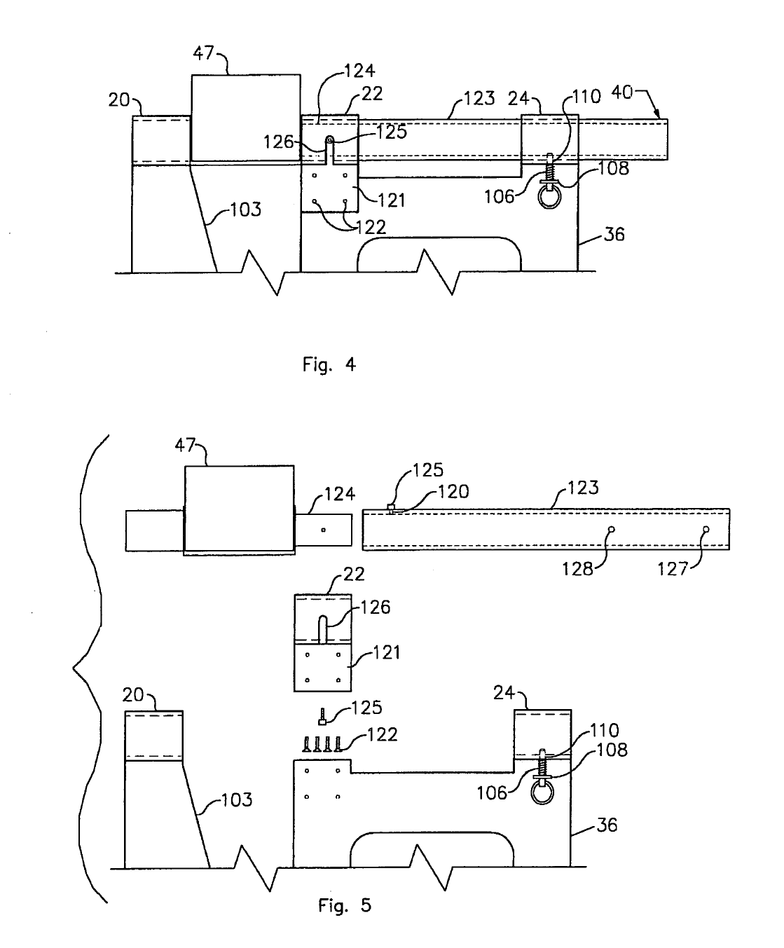

FIG. 4 shows an underside view of only one edge of the front part 36 of the frame 11 and the front cylindrical part 40 associated with it. FIG. 5 is an exploded view of the same components seen in FIG. 4 The plate 47 is joined to the front cylindrical part 40 at a location to place it between tubes 20 and 22 when the wagon 10 is assembled. This keeps the plate 47 from moving longitudinally, the tube 22 is formed with a small flange 121 and can be removably attached to the front frame part 36 by machine screws 122. In addition, the cylindrical part 40 can preferably be formed as two separate members 123 and 124 that join together telescopically. In this embodiment, the rear end of the member 124 slides into the front end of member 123, which is a tube, and can be frictionally retained by an Allen head screw 125 after the member 123 has been slid into tube 22. The tube 22 has a slot 126 that extends about 90 degrees around the tube 22 and serves as a guide for the Allen head screw 125 to limit the movement of the front cylindrical part 40, as well as the plate 47, about the axis of that cylindrical part when the locking pin 106 is pulled out of engagement with the cylindrical part 40. It should be noted that, in FIG. 5, the member 123 is shown rotated 90 degrees from its proper orientation in order to make holes 127 and 128 visible. Holes 127 and 128 receive the locking pins 99 and 106, respectively. When rotated to this orientation, the location of the 120 that receives the Allen head screw 125 is such that the position of the screw would be indicated as dotted line 123, 90 degrees removed from the orientation of the holes 127 and 128.

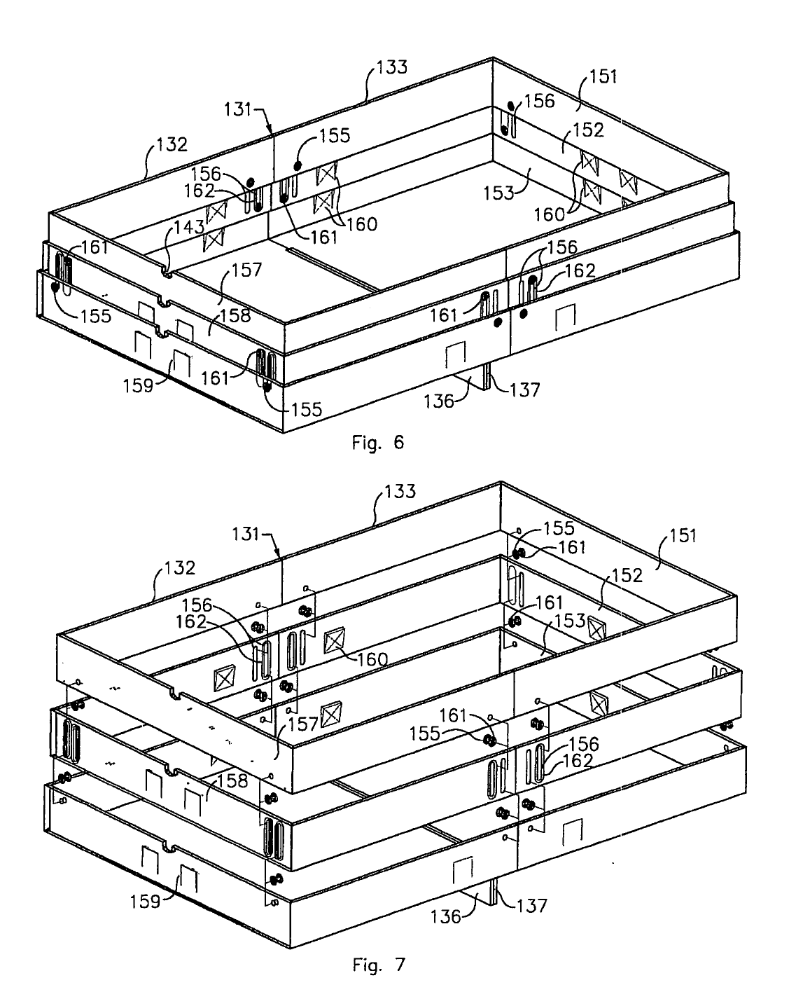

FIG. 6-7 show an orthographic view of the body 131. FIG. 7 shows an exploded view of the body 131. The body 131 is comprised of a front section 132 and a rear section 133. Construction and operation of body section 132 is identical to body section 133. Body section 133 is comprised of telescoping U shaped top rail 151, middle rail 152, and bottom rail 153. The top, middle and bottom rails 157, 158 and 159 differ from opposing respective rails 151, 152 and 153 only by notch 143. The top rail 151 and bottom rail 153 have rigidly attached slide pins 155. The middle rail 152 has four sets of elongated slots 156. Each set of slots 156 has one recessed perimeter 162 on the inside of the rail and one recessed perimeter 162 on the outside of the rail to provide clearance for the heads 161 of the slide pins 155 when the rails are moved from the extended position to the collapsed position. The length and width of rails 151, 152 and 153 are graduated so that top rail 151 has an outside length and width slightly less than the inside length and width of middle rail 152, and middle rail 152 has an outside length and width slightly less than inside length and width of bottom rail 153. The rails 151, 152, and 153 are attached to each other by means of 8 slide pins 155. The slide pins 155 ride up and down in the elongated slots 156. When rails 151 and 152 are extended up to the limits of the elongated slots 156 they can be held in place by 8 spring locks 160. The spring locks 160 can be integrally molded into the middle rail 152 and bottom rail 153. Spring locks 160 can be located near the inner part of each side of rail 152 and 153, and two spring locks 160 along the inner part of the end of rail 152 and 153 placed on each side of a centerline of the body 131.

FIGS. 8-10 show complete wagon 10, including a body 131 mounted on the frame 11 and wheels 15-18 shown in FIG. 1. These body sections need not be centered fore aft on the body 131; the front section 132 extends farther beyond the frame 11 than does the rear section 133, and the section 116 of the handle 112 extends far enough beyond the front end of the frame 11 to locate the universal joint 118 at the end of the handle section 116 beyond the front end of the body 131. This assures that the front end of the body 132 will not interfere with movement of the handle 112.

A front plate 136 and rear plate 137 can be provided to extend down from the abutting ends of the front and rear sections 132 and 133, respectively, through the gap 38 seen in FIGS. 1 and 2 and are hinged together by hinge 138. In this figure, the gap 38 is the space formed between tubes 24 and 26 and front part 36 and rear part 37. The front plate 136 is attached to the rear edge of the front section 132 by hinge 139, and the rear plate 137 is attached to the front edge of the rear section 133 by hinge 140.

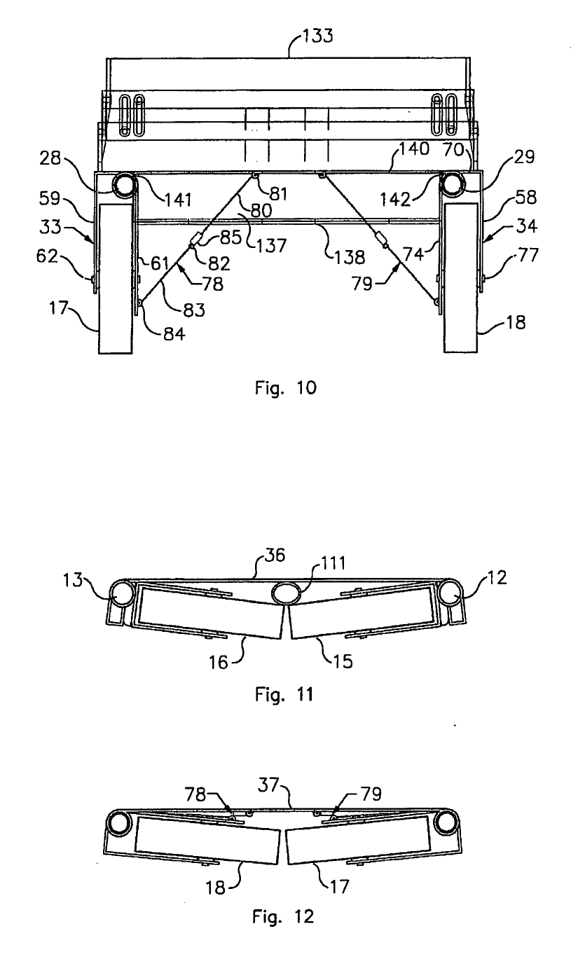

As shown in FIGS. 9 and 10, these plates 136 and 137 are not as wide as the body 131; for example, the opposite ends 141 and 142 of plate 136 fit between the cylindrical side members 12 and 13. FIG. 9 also illustrates that the wheels 15 and 16 can be swiveled entirely separately. To aid in this regard, the front wheels 15 and 16 do not include folding diagonal braces, such as braces 78 and 79 shown in FIG. 10, and are non-joined to the front cylindrical members 40 and 41 which rotate in the tubes 20, 22, 21, and 23 that hold them, as shown in FIG. 1. In addition, the tube 111 that supports the handle 112, which was shown in FIGS. 2 and 3, is seen in FIG. 9 to have an elliptical cross section, as does the handle section 116, itself, in this embodiment.

FIG. 11 shows the way the front wheels 15-16 are folded inward to stow the wagon away. All four of the wheels in this embodiment are as large as will fit between the cylindrical side members 12 and 13 in frame 11. As a result, the front wheels 15 and 16 fold to permit storage, but it may be that the tube 111 as seen in one embodiment will permit folding only far enough to engage the handle tube 111. The rear view FIG. 12 shows that the rear wheels 17 and 18 fold more nearly flat against the underside of the frame 11 limited only by the space required for the folding diagonal braces 78 and 79. The height of the sides 151-153 and 157-159 of the body 131 are configured sufficiently high enough to contain the collapsed frame 11 and wheels 15 and 16 in storage in order to permit the body 131 to be fully closed.

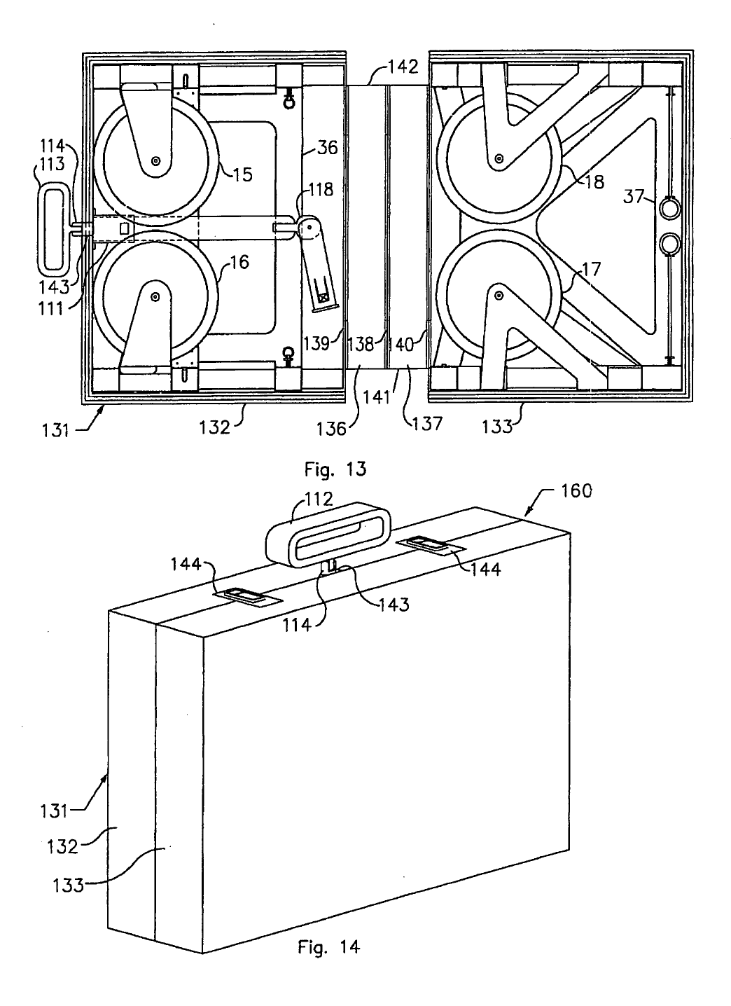

FIG. 13 shows the body 131 fully opened with the frame 11 and wheels 15 and 16 stowed in it. The front and rear parts 36 and 37 of the frame 11 are of equal width and, with the wheels 15 and 16 all folded inward, the width of these frame parts are slightly less than the interior widths of the body sections 132 and 133. The front part 36 of the frame 11 and the front wheels 15 and 16, along with the handle 112, are fitted in front section 132, and rear part 37 and the rear wheels 17 and 18 are fitted in the rear section 133. The length of the front part 36 is substantially equal to the rear part 37 so that both the front and rear parts 36 and 37 just fit into sections 132 and 133.

The handle 112 is collapsed and pushed as far into the tube 111 as possible so that the forward most section 114 will fit into a notch 143 in the body section 132 with the handgrip 113 outside the body section 132 and the cross member 115 disposed inside the body section 132. In this way when the sections are mated as seen in FIG. 14 the cross member 115 holds the handle 112 from telescoping and the handgrip 113 can be used as a carrying handle for formed case 160. The universal joint 118 at the other end of the handle 112 allows the section 116 at the other end of the handle 112 to be pivoted off to the side, as shown, so that the telescoping handle will fit in the case 160. When the body sections 132 and 133 are folded together to form the case 160, the plates 136 and 137 form a bottom that is almost fully closed.

FIG. 14 shows the body closed up with the frame and wheels inside. Provided are two latches 144 such as are commonly found on attaché cases to latch the sections 132 and 133 together. The handgrip 113 is hinged to the forward most telescoping section 114 which allows the handgrip 113 to be folded flat against either section of the closed body 131.

While the invention has been described in terms of a specific embodiment, it will be understood by those skilled in this art that modifications may be made without departing from the true scope of the invention as defined by the claims.

What is claimed is:

1. A wagon comprising:
front and rear separable frame members, each having front and rear ends and first and second sides;
first and second front wheels;
first and second rear wheels;
pivotal mounting means for said first and second front wheels, respectively, to allow each of said front wheels to pivotally connect to said front frame member in a manner to move between an operating position substantially perpendicular to said front frame member and a storage position adjacent to said front frame member;
mounting means for said first and second rear wheels, respectively, to allow each of said rear wheels to pivotally connect to said rear frame member in a manner to move between an operating position substantially perpendicular to said rear frame member and a storage position adjacent to said rear frame member; and
first releasable locking means to lock said rear frame member to said front frame member to form a rigid wagon frame.

2. The wagon of claim 1, which further includes holding means to hold said front and said rear wheels in the respective operating positions when the front and rear members are locked together.

3. The wagon of claim 1, which further includes swivel means connecting said front wheels to said front frame member.

4. The wagon of claim 1, which further includes aligning means for connecting the front and rear frame members in manner to assure alignment thereof.

5. The wagon of claim 4, comprising resiliently biased locking means for resiliently locking said aligning means.

6. The wagon of claim 2, which the holding means to hold the rear wheels in their operating positions includes foldable locking braces.

7. The wagon of claim 1, further comprising
a handle having a telescoping portion; a hand grip at a first end of said telescoping portion;
a universal joint connecting said telescoping portion having multiple concentric sections, having release latches between each said section.

8. The wagon of claim 7, including a case having a channel to receive a second end of said said handle, said universal joint and said telescoping portion of the handle when and projecting means projecting from said second end to prevent sliding out of the channel.

9. A wagon collapsible into a compact unit comprising:
front and rear frame parts;
stiffening means along left and right sides of each of said frame parts and comprising telescoping means to allow said front and rear frame parts to be removably rigidly connected together;
means for releasably locking said frame parts locked together to form a rigid wagon frame;
front and rear pairs of wheels;
means for supporting said front and rear pairs of wheels along opposite sides of said front and rear frame parts, respectively, said support means comprising pivoting means to allow each pair of wheels to fold towards each other and toward said respective frame part on which they are supported, said support means to support said front wheels comprising swivel means;
means for bracing said wheels in their respective positions substantially parallel to each other when said frame parts are locked together;
front and rear body sections pivotally joined together to be pivoted between and open position and a closed position, each comprising a bottom plate with side and end perimeter walls to form an enclosure;
hinge means for hingedly connecting said body sections together to allow said body sections to be folded either together to form an enclosure or to be flat with each bottom plate pivoted downward and said body sections pushed together to form a body for said wagon, said front frame part fitting in said front enclosure section between said walls at said perimeter thereof when said wagon is folded, said rear frame part fitting within said walls at said perimeter of said rear body section, said walls of said front body section and said rear body section when together having a height greater than said combined height of said front frame part, said rear frame part and said wheels in said closed position; and
means for releasably attaching said bottom plate of said front body section to said front frame part and said bottom plate of said rear body section to said rear frame part.

10. The collapsible wagon of claim 9, comprising a handle attached to said front frame part, said end wall of one of said body sections comprising a notch to receive said handle; and means for holding said handle extending a predetermined amount from said body sections when said frame parts are enclosed in said body sections.

11. The collapsible wagon of claim 10, in which the handle comprises a telescoping portion; pivotal handgrip at one end of said telescoping portion; a universal joint at said other end of the telescoping portion, said universal joint having an end portion at its end remote from said telescoping portion; and means for securing said universal joint to said front body part.

12. The collapsible wagon of claim 11 in which said front frame part comprises a tube to receive said end portion, said universal joint, and said telescoping portion when said end portion, said universal joint, and said telescoping portion are in aligned, sliding engagement with each other and with said tube.

13. The collapsible wagon of claim 11 which includes means for holding said handle extends a predetermined amount from said body sections including means for releasably locking said handle adjacent to an interior surface of the wall that has said notch to hold said handle in its collapsed position with said handgrip outside said enclosure.

14. A stowable wagon, which comprises:
a collapsible frame having a plurality of wheels operably connected to said frame;
a handle operably connected to said frame;
a case operably connected to said frame such that said frame and wheels in a first mode of operation support said case in a manner to permit articles to be carried within said case and a second mode of operation wherein said frame and wheels are contained within said case for storage thereof.

15. The stowable wagon of claim 14, wherein said frame includes separately connectable parts.

16. The stowable wagon of claim 14, wherein said wheels are pivotally connected to said frame.

17. The stowable wagon of claim 14, wherein said handle is telescopic.

18. The stowable wagon of claim 14, wherein said case includes expandable side walls.
